(19) United States
(12) Patent Application Publication
(10) Pub. No.: US 2015/0020740 A1
(43) Pub. Date: Jan. 22, 2015

(54) Livestock Feeder

(71) Applicant: Ted Lacey, Trent, SD (US)

(72) Inventor: Ted Lacey, Trent, SD (US)

(21) Appl. No.: 14/333,072

(22) Filed: Jul. 16, 2014

Related U.S. Application Data
(60) Provisional application No. 61/846,847, filed on Jul. 16, 2013.

(51) Int. Cl. A01K 1/10

(52) U.S. Cl. CPC A01K 1/10
USPC 119/60

(57) ABSTRACT

A livestock feeder assembly is provided that comprises an outer frame having an open interior, whereby the feeder is adapted to support hay bales in an elevated condition and above the ground for livestock to feed upon. Within the interior of the outer frame is a plurality of inwardly directed support bar members, wherein the members are secured together by way of a chain or tether at their inner distal ends. The support bar members support one or more bales of hay above the ground, whereby the height of the bales can be adjusted by updating the distance from the inner distal ends of the members. Overall, the assembly supports hay above the ground to reduce premature decomposition, and provides openings in the frame for livestock to access the hay for consumption. Different sizes, shapes and configurations of the outer frame are contemplated.

### CROSS REFERENCE TO RELATED APPLICATION

This application claims the benefit of U.S. Provisional Application No. 61/846,847 filed on Jul. 16, 2013, entitled “Cone Rod Bale Support.” The above identified patent application is herein incorporated by reference in its entirety to provide continuity of disclosure.

### BACKGROUND OF THE INVENTION

1. Field of the Invention

The present invention relates to hay bale supports and livestock feeders. More specifically, the present invention relates to a hay bale support that is adapted to elevate one or more bales of hay for consumption by animal livestock, preventing premature decomposition of the hay and reducing waste by preventing the hay from contacting soil therebelow while being stored and consumed.

Farm animals and livestock are fed a combination of hay, grass and forage as they are raised and maintained on the farm. Different methods of providing this type of food to livestock have been used in the field and proposed in the prior art, with various levels of complexity and success. Livestock feeders exist in the art and support loose hay or bales of hay using different structures and assemblies. However, most of these devices fail to recognize the waste that is created when hay is placed in contact with the ground.

Farming is a business and sometimes a means of survival for many families, therefore reducing waste and optimizing the limited resources available to the farm are critical. Common among many livestock feeders is that the feeders simply enclose the hay in a single location and do not otherwise support it above the ground. When hay is in contact with the ground, the moisture and the conditions at the base of a large bale or pile of hay can cause rapid and premature decomposition of the hay. This leads to wasted food for the livestock, as the animals will reach for fresher regions of the hay and avoid decomposing regions thereof.

This selective eating reinforces the decomposition process, as the hay is maintained and untouched along the ground for longer periods than the hay elevated thereabove. The decomposing hay is therefore discarded as waste and is periodically replaced with fresh hay. This unknowingly constitutes a great expense for many farmers with livestock, as a percentage of feed is wasted with each replacement. This percentage can sometimes amount to a considerable amount of money that may otherwise support the farm or provide profit for the farmer.

To address this problem in the art of livestock feeders, the present invention is offered as an improved livestock feeder and assembly that can support a bale of hay in an elevated state. The elevated condition of the hay and the structure of the present invention place the lower extent of the bale above the ground, maintaining the hay away from moisture and the elements that can lead to rapid decomposition. Furthermore, the livestock eats from the lower portion of the hay and the absence of decomposition means that selective eating by the livestock is less of an issue. This in turn reduces wasted feed for a farmer, and therefore saves the farmer a considerable amount of money over the long term.

2. Description of the Prior Art

Devices have been disclosed in the prior art that relate to livestock feeder assemblies. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

One such device in the prior art is U.S. Pat. No. 6,789,504 to O'Neill, which discloses a round bale hay feeder for horses, which comprises a cylindrical assembly having a series of parallel rings. The rings are spaced a distance from each other and are joined along the lower half of the assembly. The lower half further comprises a plurality of perforated floor covers to support the hay bales. Horses feed by extending their necks between the parallel rings. The O'Neill device supports hay bales and can support them in an elevated state, however the device does not share the same construction as the present invention, nor does it provide the ability to accommodate larger or smaller bales of hay, as provided herein. The present invention includes a hay bale support that can be adjusted, whereby the bale is supported higher or lower from the ground and therefore can support different sized bales within its structure.

Another device is U.S. Pat. No. 7,856,943 to Lienemann, which discloses a feeder for livestock that comprises a rounded structure having a hollow interior. The structure comprises a rounded lower portion, spaced apart bars directed inwards, and an upper portion that is of smaller diameter than the lower portion. The interior of the assembly is hollow and permits hay to freely be positioned therein. The present invention, by contrast, is adapted to support bales of hay and support the same in an elevated position. This prevents the hay from contacting earth and decomposing at a more rapid rate as compared to when elevated above the ground. The Lienemann supports loose hay and allows for efficient feeding, but fails to prevent decay of the hay that naturally occurs when the hay is in contact with the ground.

U.S. Pat. No. 5,323,734 to Meadows discloses another livestock feeder that supports a bale of hay, whereby the device comprises an elevated platform supported by inclined support legs. The platform comprises a rounded frame with a screened lower surface. An upward spear from the platform retains the position of the bale while being consumed. While providing a structure that supports a bale of hay in an elevated condition, the Meadows device does not contain the hay bale and fails to provide the adjustability or structure contemplated herein.

U.S. Pat. No. 4,706,609 to Delichte discloses yet another livestock feeder that comprises a circular frame having an outer frame and an inner frame. Both frames are rounded and comprise a fixed geometry, wherein the inner frame supports hay therein and the outer frame maintains a distance between the livestock and the hay. Similar to the Lienemann device, the Delichte device fails to contemplate a means to support bales of hay in an elevated condition. Moreover, the inner frame has a fixed width and is not suited for supporting smaller bales or substantially larger bales of hay thereon. The Delichte device is designed to maintain hay within its inner frame and offset livestock therefrom to prevent trampling of the hay. This, however, does not prevent the natural decay of hay when the same is in contact with the ground for periods of time.

Finally, U.S. Patent Publication No. 2010/0263597 to Kerns discloses a feeder that is adapted to support hay using a pyramidal-shaped support that has openings therethrough for livestock to draw the hay from the device. Hay holding support is positioned above a skirt rail and a lower frame that supports the pyramidal-shaped support thereabove. The Kerns device, while supporting hay in an elevated state, provides a fixed structure that cannot be easily adapted to support smaller or larger bales of hay. The present invention contemplates a rounded structure having inwardly directed support bars. The bars are secured together by way of a connecting tether or chain at the inner terminal end, whereby the distance between the inward support bars can be varied depending on the free length of the connecting tether. The distance between the bars dictates the height of the hay bale support, thereby accommodating larger bales if desired.

Overall, the present invention diverges significantly in structure and capability from the prior art, which are largely static structures suited for feeding livestock. It is submitted that the prior art fails to teach or contemplate the support structure provided by the present invention, and therefore fails to address the issue of premature decomposition of hay while in a feeder or provide a feeder suited for support hay in bale forms of different size. It is therefore clear that there is a need in the art for an improvement to existing livestock feeder devices in the art. In this regard the instant invention substantially fulfills these needs.

### SUMMARY OF THE INVENTION

In view of the foregoing disadvantages inherent in the known types of livestock feeders now present in the prior art, the present invention provides a new livestock feeder assembly that can be utilized for supporting bales of hay for livestock to feed upon and for preventing premature decomposition thereof.

It is therefore an object of the present invention to provide a new and improved livestock feeder assembly that has all of the advantages of the prior art and none of the disadvantages.

It is another object of the present invention to provide a livestock feeder assembly that supports bales of hay in an elevated condition and above the ground to prevent premature decomposition and to position the hay such that livestock can feed from the bottom of the hay.

Another object of the present invention is to provide a livestock feeder assembly that saves livestock farmers considerable expense in wasted hay, whereby decomposed hay from each feeder is so reduced that the farmer can see a return on investment in the assembly within a very short time.

Yet another object of the present invention is to provide a livestock feeder assembly that comprises an outer frame having various shapes, wherein a livestock access window is provided between an upper frame portion and a lower frame portion, through which the animals can access the elevated hay within the frame interior.

Another object of the present invention is to provide a livestock feeder assembly that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective side view of the livestock feeder of the present invention.

FIG. 2 shows an overhead perspective view of the livestock feeder of the present invention.

FIG. 3 shows a close-up view of the inner distal ends of the support bar members within the interior of the livestock feeder frame.

FIG. 4 shows a close-up view of the outer proximal ends of the support bar members within the interior of the livestock feeder frame.

FIG. 5 shows the multi-part construction of the frame of the present invention.

FIG. 6 shows a view of the livestock feeder of the present invention in a working state, supporting a bale of hay in an elevated position within the frame interior.

FIG. 7 shows an enlarged embodiment of the livestock feeder of the present invention, whereby multiple bales of hay are supported using the same support system.

FIG. 8 shows another embodiment of the present invention, wherein loose hay can be supported using the frame, support bar members and a rear wall.

### DETAILED DESCRIPTION OF THE INVENTION

Reference is made herein to the attached drawings. Like reference numerals are used throughout the drawings to depict like or similar elements of the livestock feeder of the present invention. For the purposes of presenting a brief and clear description of the present invention, the preferred embodiment will be discussed as used for supporting hay feed for livestock in an elevated state to prevent decomposition and selective eating by the animals. The figures are intended for representative purposes only and should not be considered to be limiting in any respect.

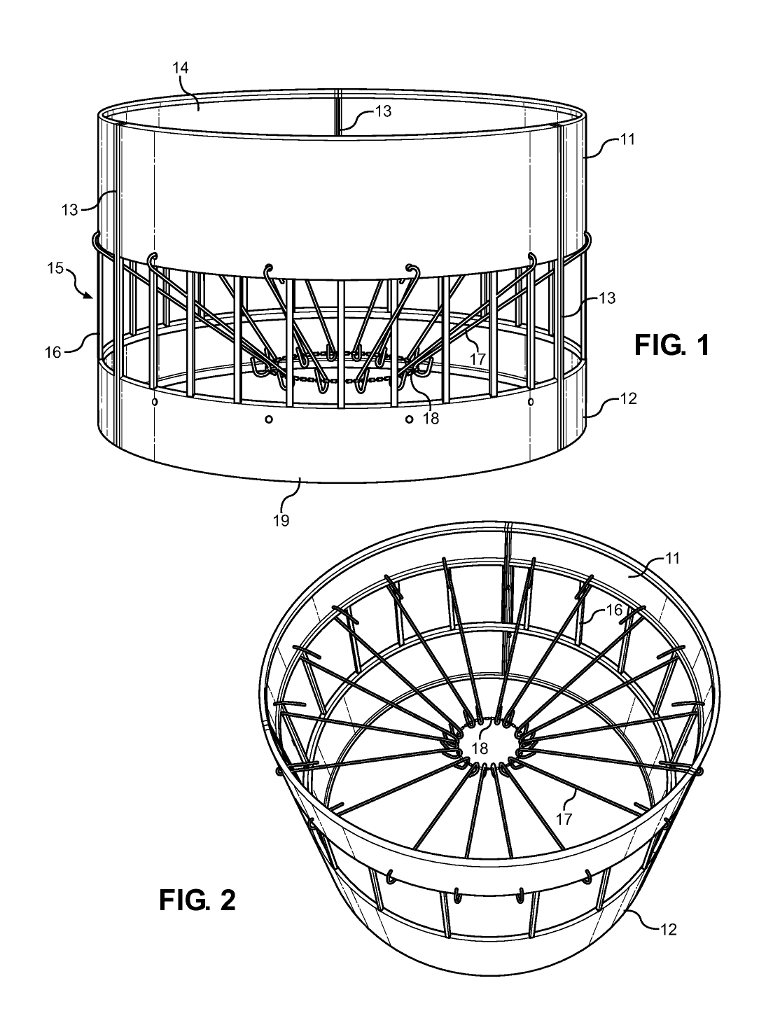

Referring now to FIG. 1, there is shown a side perspective view of the livestock feeder of the present invention. The livestock feeder comprises an outer frame having a rounded, rectangular or faceted shape, whereby the frame comprises an upper frame portion 11 and a lower frame portion 12 separated by an open portion 15 forming the feed access for animals to reach the feed supported within the interior of the frame. Disposed between the upper frame portion 11 and the lower frame portion 12 are a plurality of vertical members 16 that separate the two portions and create the open portion 15 of the frame. The vertical members 16 are disposed a given distance from one another to allow farm animals to insert their heads through the open portion 15 and reach the feed supported within the frame interior. Moreover, the length of each vertical members is such that its ends connect to the frame portions 11, 12 and separate the same a given vertical distance to allow clearance for livestock to reach therethrough with their head and necks.

In one configuration, the livestock feeder frame is a rounded assembly that is comprised of two or more segments joined together to form a continuously rounded structure. The segments are joined together at joints 13 that comprise the connected ends of each segment, which are fastened together to form the shape of the frame. Once together, the frame comprises an outer perimeter, a lower end 19 and an open upper end 14. The interior of the frame is also open, whereby hay is placed through the open upper 14 and into the frame interior for livestock to reach and feed upon.

Referring now to FIGS. 1 and 2, there is shown the hay bale support system of the present invention disposed within the interior of the assembly frame. The support system of the present invention comprises a plurality of elongated support bar members 17 that are connected at one end to the upper frame portion 11 of the assembly and connected to one another at their inner distal ends. A chain 18 or similar elongated fastener is used to secure the inner distal ends of each of the support bar members 17 together. The members 17, once connected, form a support surface upon which a bale of hay may be positioned. The inner ends of the members 17 are disposed above the ground and within the frame interior, whereby the hay is supported above the ground to prevent contact with ground moisture and ultimately to prevent rapid decay of the feed.

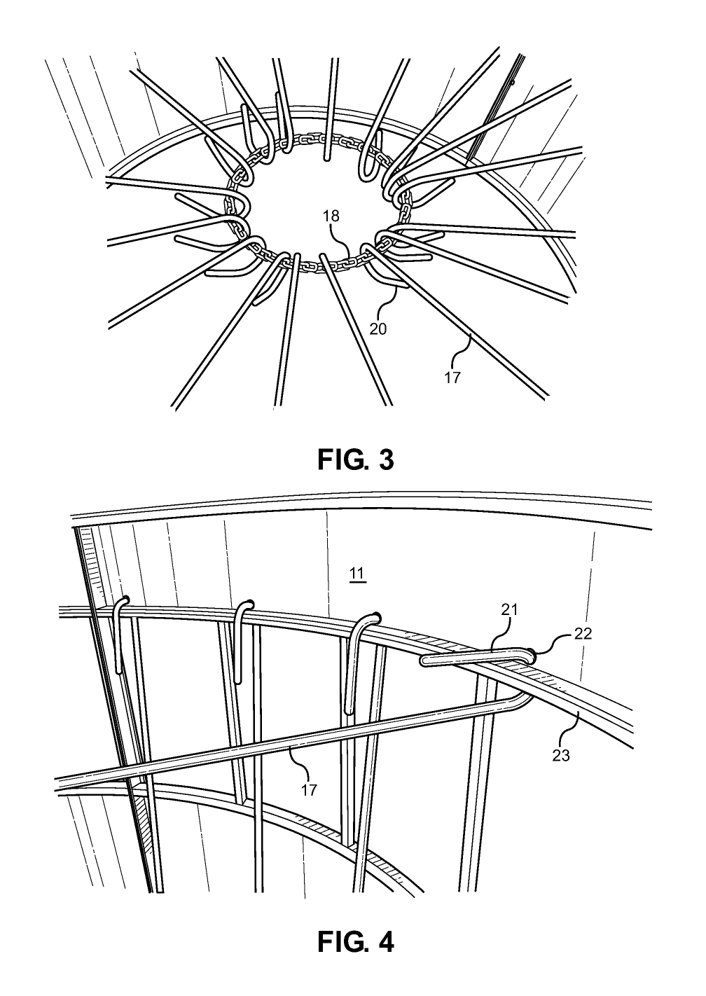

Referring now to FIG. 3, there is shown a close-up view support system along the interior of the frame. Specifically, the inner distal ends 20 of the support bar members 17 is shown and the chain 18 connection therebetween. The inner distal ends 20 comprise portions of the members 17 that are formed into a hook or an enclosed loop (i.e. an eyelet), whereby the chain tether 18 can be positioned therethrough to secure the ends 20 of each member 17 together. The chain 18 is fed through each of the loops and tensioned, whereby the tension on the chain determines the separation of the ends 20 from one another, and therefore the angle of the support bar members 17.

The angle of the support members 17 from the outer frame is defined as the angle between the support bar member 17 length and a horizontal plane aligned with the connection of the members 17 along the frame upper portion. The connection of the members 17 comprise a plurality of aligned apertures disposed within the frame upper portion. The angle of the members 17 defines the position of the inner distal ends 20 and therefor the lower extent with which a bale of hay will be positioned into the frame interior through the open upper. This determines the position of the bale lower end and therefore the offset between the ground and the hay. In this way, the height of the hay within the frame interior can be adjusted by adjusting the tension on the chain 18. The chain 18 has a first and second end secured together using an appropriate clasp or lock.

Referring now to FIG. 4, there is shown a close-up view of the connection between the support bar members 17 and the frame upper portion 11 of the assembly. The outer proximal ends 21 of the members 17 are formed into an open U-shaped hook (i.e. a shepherd's hook), whereby the ends 21 of each member 17 are positioned through apertures 22 in the frame upper portion 11. This connection allows for swift attachment and release, and furthermore allows the members 17 to pivot with respect to the frame upper portion 11. This pivoting allows the user to update the chain tension along the interior of the frame and therefore change the angle of the members 17 with respect to the frame upper portion 11. This further provides the user with the ability to attach the members without the use of hand tools, whereby the members are simply positioned through the existing apertures 22 along the lower end 23 of the frame upper portion 11.

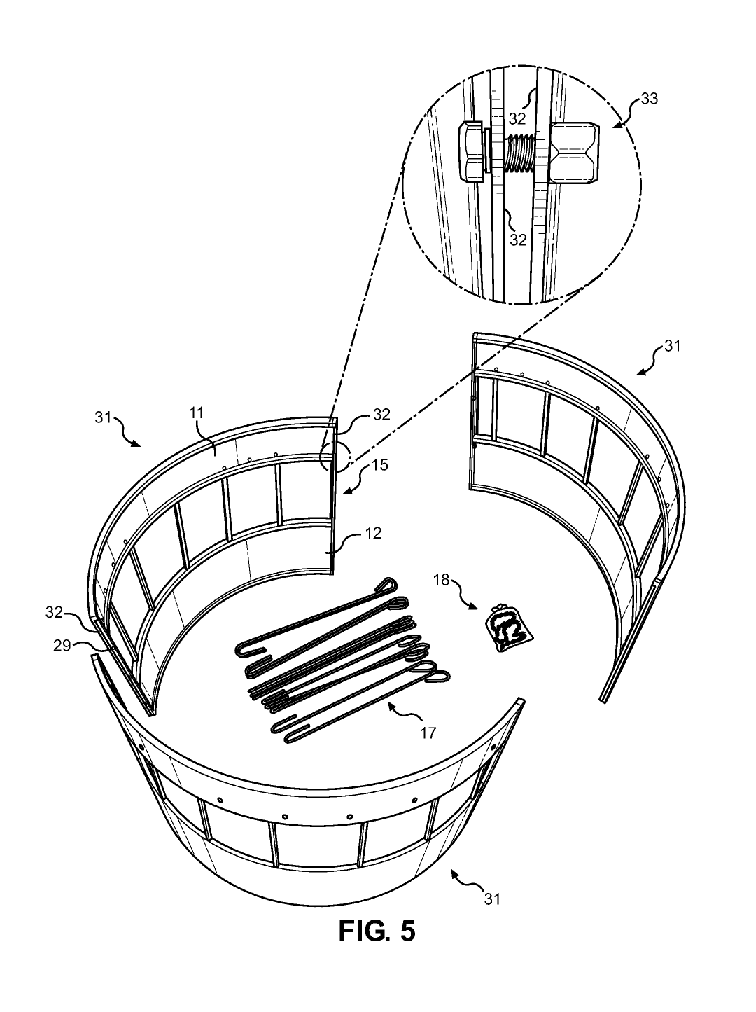

Referring now to FIG. 5, there is shown a view of the livestock feeder of the present invention and a contemplated construction, wherein the outer frame is comprised of two or more segments 31 that are fastened together. In this construction, the frame is comprised of three segments 31, each segment having a frame upper portion 11, an open portion 15, a frame lower portion 12, and frame portion ends 32 that are adapted to abut against an adjacent segment. Within the ends 32 are fastener apertures 29, whereby the fastener apertures 29 are used to support a fastener 33 therethrough when joining the segments 31 together along adjacent ends 32. A user first constructs the frame by joining the segments 31 using the fasteners 33, thereafter the support bar members 17 are connected to the constructed frame and joined together by the chain fastener 18. This construction is but one of several contemplated. The exact shape and construction of the present invention may take on several forms, wherein one skilled in the art may design different attachment methods or shapes of the frame to suit particular applications using the support system defined by the present invention.

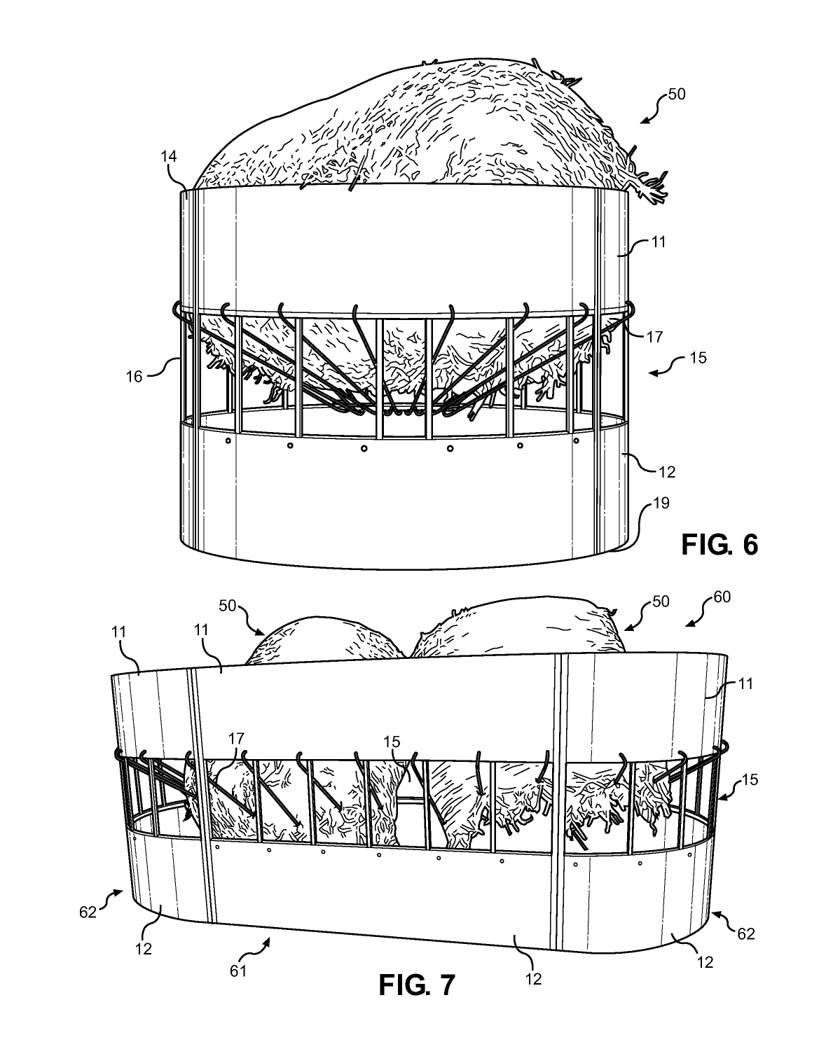

Referring now to FIG. 6, there is shown a view of the present invention in a working state, whereby a bale of hay 50 is positioned within the open interior of the frame and through the open upper 14 thereof. The lower extent of the hay is supported by the support system of the present invention within the frame, whereby the individual support bar members 17 form an angled, conical support surface upon which the hay 50 is supported. The extent with which the hay 50 is disposed within the frame and the height of the hay 50 above the ground is dictated by the angle of the members 17 and therefore the tension on the chain tether along the inner distal ends thereof. In use, the hay 50 is disposed above the ground, preventing the rapid decay that is caused after contact with wet soil and as a result of shrouded portions of the hay not exposed to light.

Once the hay 50 has been loaded into the device, the open interior portion 15 of the frame allows livestock to reach into the frame interior and access the suspended hay. The livestock animals can position their head and necks through the opening in the frame open portion 15 without straining, whereby the animals eat the hay from the bottom portion thereof. The bottom portion is generally free of decomposition, and combined with the positioning of the hay, prevents selective feeding or cherry picking hay from the top of the heap. This reduces the overall amount of time portions of the hay 50 are disposed in the feeder prior to being eaten. These factors combine to prevent waste and therefore save the farmer unnecessary expense as a result of wasted feed.

Referring now to FIG. 7, there is shown a view of another configuration of the present invention, wherein the assembly is sized to support more than one bale of hay 50. Between two rounded end segments 60 of the frame are disposed two elongated, planar frame portions 61. The planar frame portions 61 form interior frame portions between the rounded ends of the assembly. This positions the end segments 60 outward from one another and expands the open interior of the assembly. This allows more than one bale of hay 50 to be positioned therein, whereby the same support system is utilized. The support bar members 17 form one or more sets thereof, wherein each set includes support bar members 17 extending inward from the frame upper portions 11. Each set forms one, singular conical surface, wherein multiple sets may be deployed to form multiple, discrete conical surfaces within the frame interior to support individual bales of hay 50. The configuration may be decided by the user, whereby one or more chain tethers are used to secure the members 17 together into the one or more conical configurations. Each of the frame segments comprises an upper frame portion 11, an open frame portion 15, and a lower frame portion 12. The configuration of FIG. 7 is yet another arrangement contemplated herein, whereby more livestock can simultaneously feed on hay 50 supported in an elevated condition.

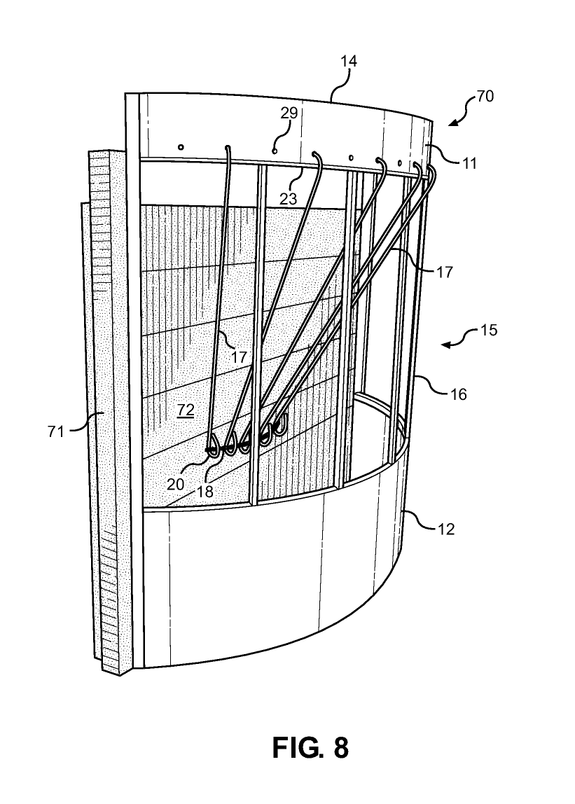

Referring finally to FIG. 8, there is shown yet another configuration of the present invention, wherein a rounded frame segment 70 is utilized in connection with a planar wall structure 71 to support hay therein using the hay support system provided above. This embodiment comprises a rounded frame segment 70 having an upper frame portion 11, an open frame portion 15, and a lower frame portion, whereby the outer ends of the frame segment 70 are secured to a planar wall structure 71. The wall structure 71 is an upstanding structure having a flat inner surface 72 disposed within the interior of the assembly. To support hay therein, the support bar members 17 extend from the frame upper portion 11 and connect together using a chain tether 18 that is connected at its ends to the wall structure 71. The outer proximal ends of the members 17 secure through apertures 29 disposed along the lower edge 23 of the frame upper portion 11. The lower distal ends 20 of the members 17 are secured together via the chain tether 18, which is removably connected to the inner surface 72 of the wall structure 71 at its ends.

Similar to the aforementioned embodiments, this embodiment also comprises an open frame portion 15 and vertical members 16 that separate the frame upper portion 11 from the frame lower portion 12. The open frame portion 15 allows animals to extend their head and neck into the frame interior to access the hay supported between the conical surface created by the support bar members 17 and the flat inner surface 72 of the wall structure 71. The shape of the frame relative to the wall structure 71 may take on several forms and shapes, falling within the scope of supporting the support bar members 17 in a fashion as described above.

Overall the assembly saves farmers by preventing feed waste. The assembly utilizes a series of rods (support bar members) with an eyelet inner distal end (first end), and a U-shaped (shepherd's hook) outer proximal end (second end). The device is easily constructed and put into active service, and is secured into desired state using a chain tether fastener or cable that is laced through the eyelet inner distal ends of each support bar member along the interior of the feeder. The chain connection in the interior of the frame and does not require additional support from the outside frame of the feeder to support hay placed thereonto, whereby the support bar members form an open, conical surface upon which the hay is placed. This allows the hay to fall into itself as it is consumed and allows livestock access to the hay while being supported, whereby the support bar members do not form a contiguous surface, but one that is separated and has gaps for the animal to access the hay. The device supports round or square bales by suspending them above the ground, which prevents them from growing mold or rotting. The assembly can also be adjusted to keep the hay away from the reach of an animal, which restricts the amount of feed consumed by the animal, or can be adjusted to hang low with large openings that allow the feed to be pulled out with ease.

Overall, it is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A livestock feeder assembly, comprising:
an outer frame having a frame upper portion, a frame lower portion, and an open frame portion therebetween;
at least one set of elongated support bar members having an outer proximal end and an inner distal end;
said outer proximal end of each support bar member being removably attached to said frame upper portion;
said inner distal end of each set of elongated support bar members secured together via a tether;
each one set of elongated support bar members forming a substantially conical support surface.

2) The livestock feeder assembly of claim 1, wherein:
said substantially conical support surface comprises a lower extent defined by said inner distal ends;
said lower extent adapted to be positioned in an elevated state above a ground surface.

3) The livestock feeder assembly of claim 1, wherein:
each outer proximal of the elongated support bar members further comprises a U-shaped hook adapted to be received through an aperture in the frame upper portion.

4) The livestock feeder assembly of claim 1, wherein:
each inner distal end of the elongated support bar members comprises an enclosed loop through which said tether is adapted to be received.

5) The livestock feeder assembly of claim 1, wherein said tether further comprises a chain having a first end and a second end that can be joined together to form a closed-loop tether.

6) The livestock feeder assembly of claim 1, wherein said outer frame is comprised of two or more frame segments.

7) The livestock feeder assembly of claim 1, wherein said outer frame is has a rounded shape.

8) The livestock feeder assembly of claim 1, wherein said outer frame is has rounded ends and planar frame portions therebetween.

9) A method of feeding livestock and preventing premature decomposition of feed, comprising the steps of:
supporting feed in an elevated position using a livestock feeder assembly having at least one substantially conical support surface defined by one or more sets of elongated support bar members extending inwardly within an outer frame, each of said conical support surface having a lower extent;
positioning the lower extent of each conical support surface above a ground surface to prevent contact between said feed and said ground surface;
providing an open portion through said outer frame for livestock to access said feed supported on each conical support surface.

10) The method of claim 9, further comprising the steps of:
setting said lower extent of each conical support surface using a tether connected to each of said gated support bar members at the lower distal ends thereof;
said tether having a length, whereby said length adjusts the relative position of said the lower distal ends relative to one another at said lower extent.

11) The method of claim 9, further comprising the steps of:
setting said lower extent of each conical support surface using a tether connected to each of said gated support bar members at the lower distal ends thereof;
said tether having a length, whereby said length adjusts the angle of said elongated support bar members relative to said outer frame, and thus the angle of said conical support surface and the height of said lower extent.
